(19) United States
(12) Patent Application Publication
(10) Pub. No.: US 2024/0053798 A1
(43) Pub. Date: Feb. 15, 2024

(54) PORTABLE MAGNETIC CHARGING PANEL

(71) Applicant: Shanghai EdgelnterLink Technology Co., Ltd., Shanghai (CN)

(72) Inventor: YUEWU ZHAO, Shanghai (CN)

(21) Appl. No.: 17/970,379

(22) Filed: Oct. 20, 2022

(30) Foreign Application Priority Data
Aug. 11, 2022 (CN) 2022221145848

(51) Int. Cl. G06F 1/16; H02J 7/00; A45C 11/00

(52) U.S. Cl. CPC G06F 1/1632; H02J 7/0047; H02J 7/0045; A45C 11/00; A45C 2011/003

(57) ABSTRACT

A portable magnetic charging panel includes a tablet computer protection shell and a pedestal. The pedestal includes a charging base and a support. The charging base is fixed on the support. The entire charging base is cuboid. An adapter connection port is provided on a right face of the charging base. A circuit board connected to the adapter connection port is mounted inside the charging base. A separation blade is arranged at an edge of an upper face of the charging base. A connection slot is formed between the separation blade and the support. The tablet computer protection shell is detachably mounted in the connection slot. A side face of the table protection shell is provided with a bayonet. A charger head connected to a tablet computer charging jack is arranged on the bayonet; and the charger head is electrically connected to the circuit board inside the charging base.

### CROSS-REFERENCE TO RELATED APPLICATIONS

The application claims priority of Chinese patent application CN202222114584.8, filed on Aug. 11, 2022, which is incorporated herein by reference in its entireties.

### TECHNICAL FIELD

The present disclosure relates to the technical field of charging of tablet devices, in particular, to a portable magnetic charging panel.

### BACKGROUND

With the prosperity of the city and the increasing number of residents, the service industry is essential for the economic activities, and the service industry has gradually turned to serve people. The relatively high productivity and the developed social division of labor created by socialized mass production have prompted some labors, serving for production, in production enterprises to be gradually separated from a production process (for example, a maintenance workshop of a factory has gradually become a repair enterprise). These labors join in the service industry and become an independent industry serving for production.

The service industry mainly includes service staff and consumers. Nowadays, with the well development of science and technology, electronic products have been applied to the service industry due to their increasingly powerful functions. An intelligent calling system is formed between the service staff and the customers nowadays using tablet computers in the service industry. The tablet computer will consume electricity when they are in use, and timely charging is necessary. A charging data wire for charging cannot meet the requirement. Meanwhile, a data wire or joint may fail or be in poor contact since it is required to be plugged for charging, resulting in a charging failure.

In another aspect, an existing charging base is inconvenient to move and cannot satisfy the use of consumers.

The preceding statements are intended to provide general background information and may not constitute the prior art.

### SUMMARY

The present disclosure aims to provide a portable magnetic charging panel. The portable magnetic charging panel can protect a tablet computer and charge the tablet computer, has a simple structure, is convenient to move, and can satisfy the use of customers.

The present disclosure also adopts the following technical solution: a portable magnetic charging panel including a tablet computer protection shell and a pedestal, wherein the pedestal includes a charging base and a support; the charging base is fixed on the support; the entire charging base is cuboid; an adapter connection port is provided on a right face of the charging base; a circuit board connected to the adapter connection port is mounted inside the charging base; a quick charging agreement recognition chip is arranged on the circuit board; a separation blade is arranged at an edge of an upper face of the charging base; a connection slot is formed between the separation blade and the support; the tablet computer protection shell is detachably mounted in the connection slot; a side face of the table protection shell is provided with a bayonet; a charger head connected to a tablet computer charging jack is arranged on the bayonet; and the charger head is electrically connected to the circuit board inside the charging base.

Further, a cross section of the support is “L”-shaped; the support includes a baffle plate and a bottom plate; an edge of the bottom plate is connected with the baffle plate; the charging base is fixed on the baffle plate; and the connection slot is formed between the separation blade and the baffle plate.

Further, an included angle between the baffle plate and the bottom plate is 30-60 degrees.

Further, the connection slot and the tablet computer protection shell are connected in a magnetic attraction manner.

Further, a front face of the charging base is provided with a switch used for controlling charging to be enabled and disabled; and two charging indicators are arranged beside the switch.

Further, a bottom of the connection slot is provided with a metal contact; the metal contact is connected to the circuit board inside the charging base; a bottom of the tablet computer protection shell is provided with a metal contact hole matched with the metal contact; the metal contact hole is electrically connected with the charger head through a lead wire; and the metal contact is plugged into the metal contact hole when the tablet computer protection shell is connected to the connection slot.

Further, the metal contact and the metal contact hole form a pogo pin connector.

Further, a handle hole is formed in the bottom plate.

Further, a camera opening is formed in the tablet computer protection shell.

Further, a supporting frame is arranged on a back face of the tablet computer protection shell.

The present disclosure also adopts the following technical solution: a portable magnetic charging panel, including a tablet computer protection shell and a pedestal, wherein the pedestal includes a charging base and a support connected to the charging base; an adapter connection port is provided on the charging base; a circuit board connected to the adapter connection port is mounted inside the charging base; a separation blade is arranged at an edge of an upper face of the charging base; a connection slot is formed between the separation blade and the support; the tablet computer protection shell is configured to be detachably mounted in the connection slot; a side face of the table protection shell is provided with a bayonet; a charger head connected to a tablet computer charging jack is arranged on the bayonet; and the charger head is electrically connected to the circuit board inside the charging base.

Further, a cross section of the support is “L”-shaped; the support includes a baffle plate and a bottom plate; an edge of the bottom plate is connected with the baffle plate; the charging base is fixed on the baffle plate; and the connection slot is formed between the separation blade and the baffle plate.

Further, an included angle between the baffle plate and the bottom plate is 30-60 degrees.

Further, the connection slot and the tablet computer protection shell are connected in a magnetic attraction manner.

Further, a front face of the charging base is provided with a switch used for controlling charging to be enabled and disabled; and two charging indicators are arranged beside the switch.

Further, a bottom of the connection slot is provided with a metal contact; the metal contact is connected to the circuit board inside the charging base; a bottom of the tablet computer protection shell is provided with a metal contact hole matched with the metal contact; the metal contact hole is electrically connected with the charger head through a lead wire; and the metal contact is plugged into the metal contact hole when the tablet computer protection shell is connected to the connection slot.

Further, the metal contact and the metal contact hole form a pogo pin connector.

Further, a handle hole is formed in the bottom plate.

1Further, a camera opening is formed in the tablet computer protection shell.

Further, a supporting frame is arranged on a back face of the tablet computer protection shell.

The present disclosure has the beneficial effects: by means of the design of the tablet computer protection shell and the charging base, the portable magnetic charging panel of the present disclosure has a simple structure, is convenient to move, and can satisfy the use of customers. Meanwhile, the charger head does not need to be repeatedly plugged and unplugged since the tablet computer protection shell is detachably connected to the connection slot, so that the problem that a data wire needs to be plugged to achieve charging of the traditional tablet computer is changed, and the problem of a charging failure caused by a fact that the data wire or joint fails or is in poor contact is prevented. The charger head connected to the tablet computer charging jack is arranged on the tablet computer protection shell, which changes such a phenomenon that the conventional protection case only plays a pure protection role for the tablet computer, so that the tablet computer can be protected and also charged; and the protection case is multifunctional.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic structural diagram of a portable magnetic charging panel provided according to Embodiment 1 of the present disclosure.

FIG. 2 is a schematic diagram of a split structure of the portable magnetic charging panel in FIG. 1.

FIG. 3 is a schematic structural diagram of a tablet computer protection shell of the portable magnetic charging panel in FIG. 1.

FIG. 4 is a schematic structural diagram of the tablet computer protection shell of the portable magnetic charging panel in FIG. 1 from another angle of view.

FIG. 5 is a schematic structural diagram of the tablet computer protection shell of the portable magnetic charging panel in FIG. 1 from the rear view.

FIG. 6 is a schematic structural diagram of a pedestal of the portable magnetic charging panel in FIG. 1.

FIG. 7 is a schematic structural diagram of a support of the portable magnetic charging panel in FIG. 1.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, “a plurality of” means two or more, unless otherwise specifically defined.

### Embodiment 1

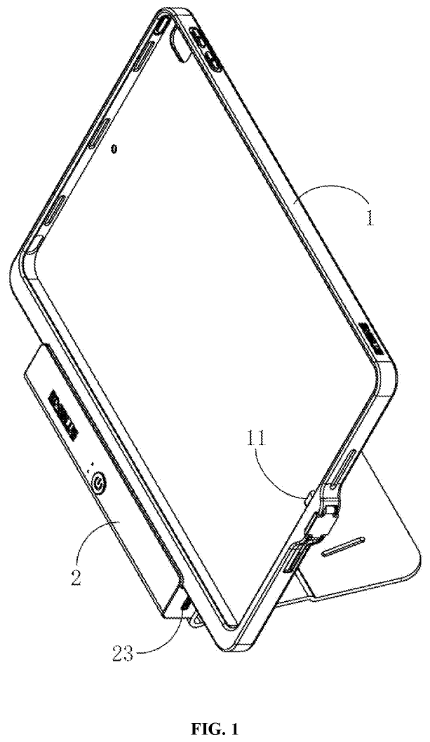

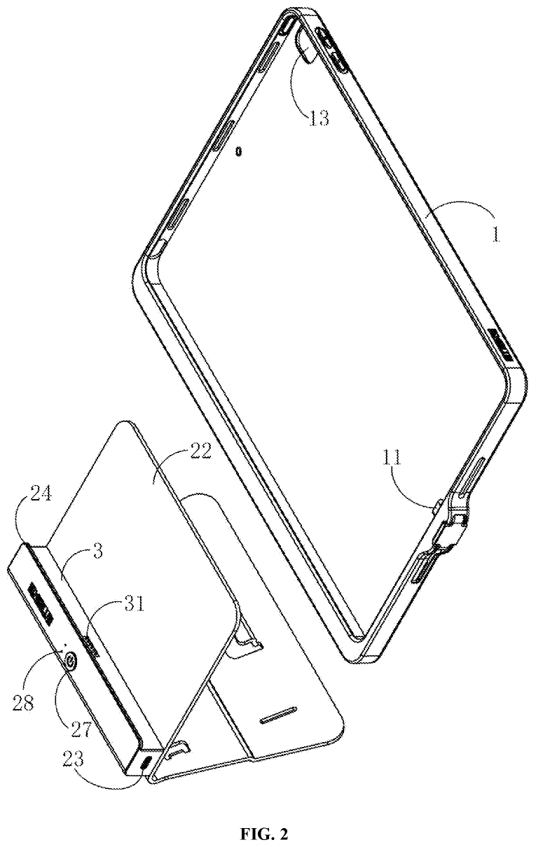

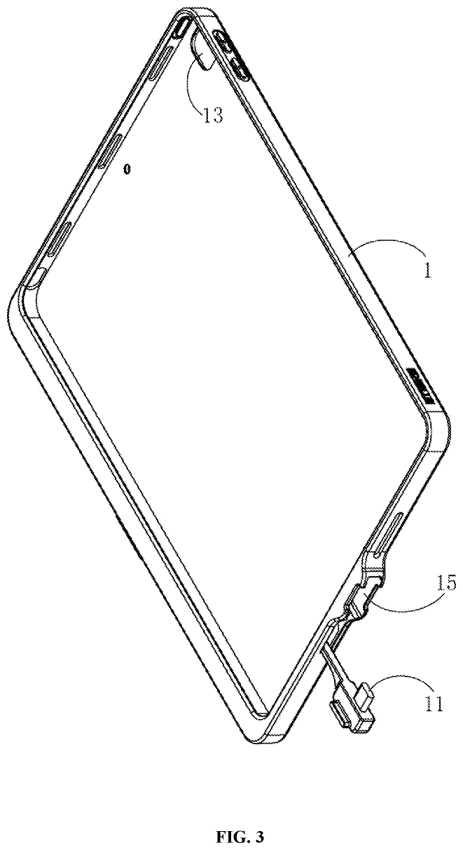

Referring to FIG. 1, FIG. 2, and FIG. 3, a portable magnetic charging panel provided in this embodiment of the present disclosure includes a tablet computer protection shell 1 and a pedestal 2; the pedestal 2 includes a charging base 21 and a support 22; the charging base 21 is fixed on the support 22; the entire charging base 21 is cuboid; an adapter connection port 23 is provided on a right face of the charging base 21; a circuit board connected to the adapter connection port 23 is mounted inside the charging base 21; a quick charging agreement recognition chip is arranged on the circuit board; a separation blade 24 is arranged at an edge of an upper face of the charging base 21; a connection slot 3 is formed between the separation blade 24 and the support 22; the tablet computer protection shell 1 is detachably mounted in the connection slot 3; a side face of the table protection shell 1 is provided with a bayonet 15; a charger head 11 connected to a tablet computer charging jack is arranged on the bayonet 15 (the charger head 11 may be removed from the bayonet 15, so that in a case that the tablet computer protection shell 1 is not put back to the pedestal 2, a tablet computer can still be connected to an original charging wire for charging, without removing the tablet computer protection shell 1 and taking out the tablet computer); and the charger head 11 is electrically connected to the circuit board inside the charging base 21.

When the tablet computer needs to be charged, an adapter connected to the adapter connection port 23 is first connected to a power supply; the tablet computer is then placed in the tablet computer protection shell 1, and the charger head 11 is plugged into the tablet computer charging jack; and the quick charging agreement recognition chip transmits a voltage provided by the adapter on the adapter connection port 23 to the tablet computer protection shell 1 to quickly charge the tablet computer.

By means of the design of the tablet computer protection shell 1 and the charging base 21, the portable magnetic charging panel of the present disclosure has a simple structure, is convenient to move, and can satisfy the use of customers. Meanwhile, the charger head 11 does not need to be repeatedly plugged and unplugged since the tablet computer protection shell 1 is detachably connected to the connection slot 3, so that the problem that a data wire needs to be plugged to achieve charging of the traditional tablet computer is changed, and the problem of a charging failure caused by a fact that the data wire or joint fails or is in poor contact is prevented. The charger head 11 connected to the tablet computer charging jack is arranged on the tablet computer protection shell 1, which changes such a phenomenon that the conventional protection case only plays a pure protection role for the tablet computer, so that the tablet computer can be protected and also charged; and the protection case is multifunctional.

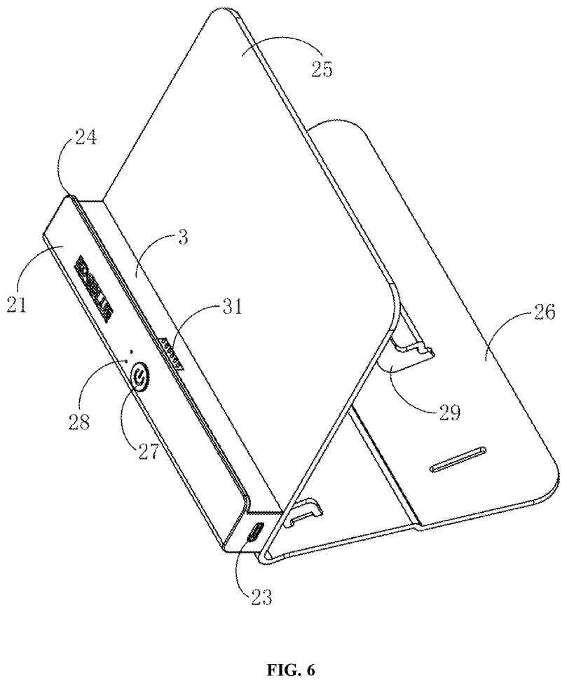

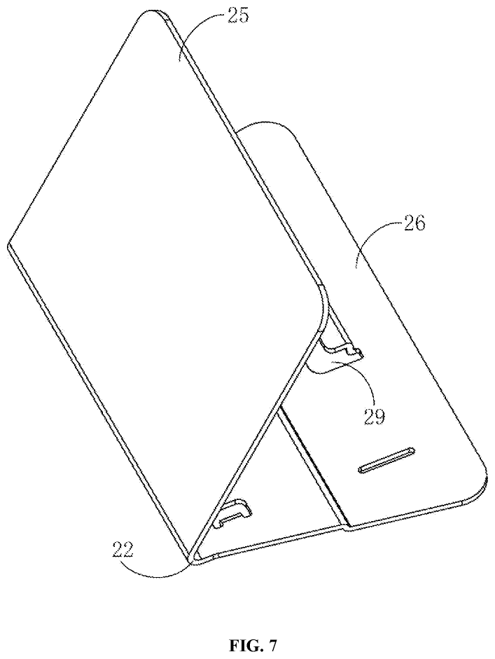

Referring to FIG. 6 and FIG. 7, a cross section of the support 22 is “L”-shaped; the support 22 includes a baffle plate 25 and a bottom plate 26; an edge of the bottom plate 26 is connected with the baffle plate 25; the charging base 21 is fixed on the baffle plate 25; and the connection slot 3 is formed between the separation blade 24 and the baffle plate 25. An included angle between the baffle plate 25 and the bottom plate 26 is 30-60 degrees, thus ensuring the stability of supporting of the support 22 to the tablet computer protection shell 1.

The connection slot 3 and the tablet computer protection shell 1 of the present disclosure is magnetic attraction connection. By means of the magnetic attraction connection, it is convenient for mounting and removal.

As shown in FIG. 2, a front face of the charging base 21 is provided with a switch 27 used for controlling charging to be enabled and disabled; and two charging indicators 28 are arranged beside the switch 27 to display states of being charged or charging completed.

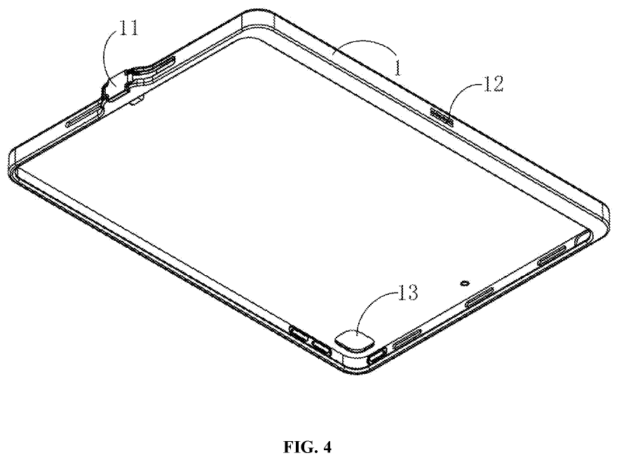

Referring to FIG. 4 and FIG. 6, a bottom of the connection slot 3 of the present disclosure is provided with a metal contact 31; the metal contact 31 is connected to the circuit board inside the charging base 21; a bottom of the tablet computer protection shell 1 is provided with a metal contact hole 12 matched with the metal contact 31; the metal contact hole 12 is electrically connected with the charger head 11 through a lead wire; and the metal contact 31 is plugged into the metal contact hole 12 when the tablet computer protection shell 1 is connected to the connection slot 3.

The connection and cooperation between the metal contact 31 and the metal contact hole 12 changes the problem that a data wire needs to be plugged to achieve charging of the traditional tablet computer, and prevents the problem of a charging failure caused by a fact that the data wire or joint fails or is in poor contact.

The metal contact 31 and the metal contact hole 12 of the present disclosure form a pogo pin connector. Specifically, due to the design of the pogo pin connector, the tablet computer is charged by the contact between two metal contacts, thus preventing the problem of a charging failure caused by a fact that the data wire or joint fails or is in poor contact; and the process of manually plugging and unplugging the data wire is eliminated, so that the labor intensity is reduced, and the charging efficiency is improved.

Pogo pin is a six-point pogo pin. Compared with a three-point pogo pin, the six-point pogo pin also has a communication function in addition to the charging function.

As shown in FIG. 7, in the present disclosure, a handle hole 29 is formed in the bottom plate 26, which is further convenient for picking up and moving the portable magnetic charging panel.

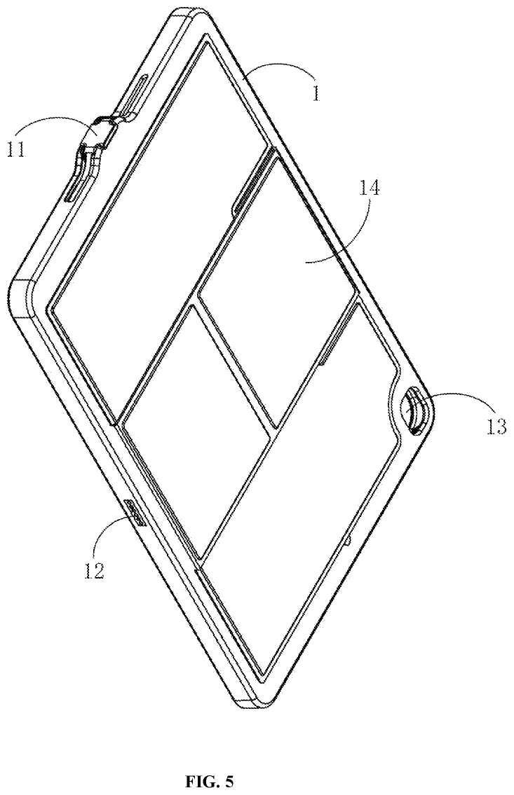

Referring to FIG. 3, FIG. 4, and FIG. 5, a camera opening 13 is formed in the tablet computer protection shell 1 provided by the present disclosure. The tablet computer can take photos and videos through the camera opening 13.

A supporting frame 14 is arranged on a back face of the tablet computer protection shell 1. The tablet computer protection shell 1 can be supported on a plane through the supporting frame 14 when the tablet computer protection shell 1 is taken down from the pedestal 2, which is convenient for use.

### Embodiment 2

A difference between this embodiment and Embodiment 1 is that:

In this embodiment, a plurality of portable magnetic charging panels are arranged to simultaneously charge a plurality of tablet computers, thus improving the charging efficiency.

Any number of portable magnetic charging panels of the present disclosure can be combined, or one portable magnetic charging panel can be used alone.

### Embodiment 3

A difference between this embodiment and Embodiment 1 lies in the adapter connection port 23, the switch 27, and the charging indicator 28.

The adapter connection ports 23 are arranged on a left face and a right face of the charging base 21 of the portable magnetic charging panel provided in this embodiment. A user can charge a tablet computer at different positions since the adapter connection ports 23 are arranged on both the left face and the right face. The same charging effect can be achieved by randomly plugging the wire to one of the adapter connection ports 23 on the left face and the right face. The switch 27 and the two charging indicators 28 are located at the middle position of the front face of the charging base 21, which is convenient for operation.

According to the portable magnetic charging panel provided by the present disclosure, when the tablet computer needs to be charged, an adapter connected to the adapter connection port 23 is first connected to a power supply; the tablet computer is then placed in the tablet computer protection shell 1, and the charger head 11 is plugged into the tablet computer charging jack; and the quick charging agreement recognition chip transmits a voltage provided by the adapter on the adapter connection port 23 to the tablet computer protection shell 1 to quickly charge the tablet computer. By means of the design of the tablet computer protection shell 1 and the charging base 21, the portable magnetic charging panel has a simple structure, is convenient to move, and can satisfy the use of customers. Meanwhile, the charger head 11 does not need to be repeatedly plugged and unplugged since the tablet computer protection shell 1 is detachably connected to the connection slot 3, so that the problem that a data wire needs to be plugged to achieve charging of the traditional tablet computer is changed, and the problem of a charging failure caused by a fact that the data wire or joint fails or is in poor contact is prevented. The charger head 11 connected to the tablet computer charging jack is arranged on the tablet computer protection shell 1, which changes such a phenomenon that the conventional protection case only plays a pure protection role for the tablet computer, so that the tablet computer can be protected and also charged; and the protection case is multifunctional.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A portable magnetic charging panel, comprising a tablet computer protection shell and a pedestal, wherein the pedestal comprises a charging base and a support; the charging base is fixed on the support; the entire charging base is cuboid; an adapter connection port is provided on a right face of the charging base; a circuit board connected to the adapter connection port is mounted inside the charging base; a quick charging agreement recognition chip is arranged on the circuit board;
a separation blade is arranged at an edge of an upper face of the charging base; a connection slot is formed between the separation blade and the support; the tablet computer protection shell is detachably mounted in the connection slot; a side face of the table protection shell is provided with a bayonet; a charger head connected to a tablet computer charging jack is arranged on the bayonet; and the charger head is electrically connected to the circuit board inside the charging base.

2. The charging panel according to claim 1, wherein a cross section of the support is “L”-shaped; the support comprises a baffle plate and a bottom plate; an edge of the bottom plate is connected with the baffle plate; the charging base is fixed on the baffle plate; and the connection slot is formed between the separation blade and the baffle plate.

3. The charging panel according to claim 2, wherein an included angle between the baffle plate and the bottom plate is 30-60 degrees.

4. The charging panel according to claim 1, wherein the connection slot and the tablet computer protection shell are connected in a magnetic attraction manner.

5. The charging panel according to claim 1, wherein a front face of the charging base is provided with a switch used for controlling charging to be enabled and disabled; and two charging indicators are arranged beside the switch.

6. The charging panel according to claim 1, wherein a bottom of the connection slot is provided with a metal contact; the metal contact is connected to the circuit board inside the charging base; a bottom of the tablet computer protection shell is provided with a metal contact hole matched with the metal contact; the metal contact hole is electrically connected with the charger head through a lead wire; and
the metal contact is plugged into the metal contact hole when the tablet computer protection shell is connected to the connection slot.

7. The charging panel according to claim 6, wherein the metal contact and the metal contact hole form a pogo pin connector.

8. The charging panel according to claim 2, wherein a handle hole is formed in the bottom plate.

9. The charging panel according to claim 1, wherein a camera opening is formed in the tablet computer protection shell.

10. The charging panel according to claim 1, wherein a supporting frame is arranged on a back face of the tablet computer protection shell.

11. A portable magnetic charging panel, comprising a tablet computer protection shell and a pedestal, wherein the pedestal comprises a charging base and a support connected to the charging base; an adapter connection port is provided on the charging base; a circuit board connected to the adapter connection port is mounted inside the charging base;
a separation blade is arranged at an edge of an upper face of the charging base; a connection slot is formed between the separation blade and the support; the tablet computer protection shell is configured to be detachably mounted in the connection slot; a side face of the table protection shell is provided with a bayonet; a charger head connected to a tablet computer charging jack is arranged on the bayonet; and the charger head is electrically connected to the circuit board inside the charging base.

12. The charging panel according to claim 11, wherein a cross section of the support is “L”-shaped; the support comprises a baffle plate and a bottom plate; an edge of the bottom plate is connected with the baffle plate; the charging base is fixed on the baffle plate; and the connection slot is formed between the separation blade and the baffle plate.

13. The charging panel according to claim 12, wherein an included angle between the baffle plate and the bottom plate is 30-60 degrees.

14. The charging panel according to claim 11, wherein the connection slot and the tablet computer protection shell are connected in a magnetic attraction manner.

15. The charging panel according to claim 11, wherein a front face of the charging base is provided with a switch used for controlling charging to be enabled and disabled; and two charging indicators are arranged beside the switch.

16. The charging panel according to claim 11, wherein a bottom of the connection slot is provided with a metal contact; the metal contact is connected to the circuit board inside the charging base; a bottom of the tablet computer protection shell is provided with a metal contact hole matched with the metal contact; the metal contact hole is electrically connected with the charger head through a lead wire; and
the metal contact is plugged into the metal contact hole when the tablet computer protection shell is connected to the connection slot.

17. The charging panel according to claim 16, wherein the metal contact and the metal contact hole form a pogo pin connector.

18. The charging panel according to claim 12, wherein a handle hole is formed in the bottom plate.

19. The charging panel according to claim 11, wherein a camera opening is formed in the tablet computer protection shell.

20. The charging panel according to claim 11, wherein a supporting frame is arranged on a back face of the tablet computer protection shell.
